(19) United States
(12) Patent Application Publication
(10) Pub. No.: US 2018/0113974 A1
(43) Pub. Date: Apr. 26, 2018

(54) Neural Network Based Prediction of PCB Glass Weave Induced Skew

(71) Applicant: International Business Machines Corporation, Armonk, NY (US)

(72) Inventors: Dylan J. Boday, Tucson, AZ (US); Zhaoqing Chen, Poughkeepsie, NY (US); Jose A. Hejase, Austin, TX (US); Roger S. Krabbenhoft, Rochester, MN (US); Pavel Roy Paladhi, Austin, TX (US); Junyan Tang, Austin, TX (US)

(21) Appl. No.: 15/299,546

(22) Filed: Oct. 21, 2016

(51) Int. Cl. G06F 17/50; G06N 3/08; G06N 3/04

(52) U.S. Cl. CPC G06F 17/5077; G06F 2217/06; G06N 3/04; G06N 3/08

(57) ABSTRACT

Mechanisms are provided for implementing a skew rate artificial neural network (ANN). The mechanisms generate a training dataset for training the skew rate ANN. The training dataset comprises a plurality of sets of data and each set of data corresponds to a particular set of printed circuit board (PCB) and communication channel characteristics. The mechanisms train the skew rate ANN based on the training dataset to generate a trained skew rate ANN. The mechanisms then receive an input dataset representing a set of PCB and communication channel characteristics for a PCB design. The trained skew rate ANN generates a predicted skew factor for the PCB design based on the input dataset. The predicted skew factor is then output to a PCB design tool to modify the PCB design based on the predicted skew factor.

### BACKGROUND

The present application relates generally to an improved data processing apparatus and method and more specifically to mechanisms for predicting printed circuit board (PCB) glass weave induced skew using a neural network based methodology.

In computer technology, processors are generally interconnected with each other, and other peripheral devices or systems, such as storage systems or network switches, via high speed communication channels (or buses). These high speed channels or buses may be implemented in many different forms which are constrained by cost, reliability, available manufacturing options, and technological limitations. Such constraints may cause choices to be made as to the implementation to utilize including, for example, using differential or single ended wiring, determining the wiring density to be utilized, determining various PCB design characteristics (such as thickness, layer quantity and material properties, etc.), determining the types of connectors, via types and properties, and the like. No matter what design choices are made for the implementation of the high speed channel or bus design, it is always important to achieve good signal integrity.

Striplines, i.e. a transvers electromagnetic (TEM) transmission line medium comprising a central conductor sandwiched between ground planes, wired in a differential fashion have been used for many years in high speed channel design as they are more robust with regard to signal distortion and external interference than tradition single ended lines when designed appropriately. A key implementation challenge of differential-pair striplines though is maintaining uniform stripline impedance throughout the length of the pair of striplines. Any uneven change in dimensions or dielectric constant of the surrounding dielectric material leads to differential impedance changes and a differential-to-common-mode conversion. The total signal delay seen by each stripline within the pair ideally would be the same with any differential in the delays leading to a differential-to-common-mode conversion, thus degrading the quality of the differential signal. The difference in delay between the two striplines within the differential pair is called skew. Ideally for best signal integrity, “within-differential-pair-skew”, i.e. the difference in timing of signals within a differential pair, should be zero.

Within-differential-pair-skew can be caused by a variety of factors. Most importantly these factors include copper etch length difference of both striplines of the differential pair and dielectric surrounding heterogeneity caused by glass weaves in PCB laminates. While the copper length difference of the striplines composing a differential pair can be mitigated by matching lengths on the board, the glass weave effects must be treated more carefully.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided, in a data processing system comprising at least one processor and at least one memory, the at least one memory comprising instructions executed by the at least one processor to cause the at least one processor to implement a skew rate artificial neural network (ANN). The method comprises generating, by the data processing system, a training dataset for training the skew rate ANN. The training dataset comprises a plurality of sets of data, and wherein each set of data corresponds to a particular set of printed circuit board (PCB) and communication channel characteristics. The method further comprises training, by the data processing system, the skew rate ANN based on the training dataset to generate a trained skew rate ANN, and receiving, by the data processing system, an input dataset representing a set of PCB characteristics and communication channel characteristics for a PCB design and communication channel of the PCB design. Moreover, the method comprises generating, by the trained skew rate ANN executing on the data processing system, a predicted skew factor for the communication channel based on the input dataset. In addition, the method comprises outputting, by the data processing system, the predicted skew factor for the communication channel to a PCB design tool to modify the PCB design based on the predicted skew factor.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram illustrating a differential stripline pair embedded between two ground layers and surrounded by dielectric;

FIG. 2A shows an example of a worst case orthogonal orientation of a differential stripline pair relative to a glass weave;

FIG. 2B shows an illustration of a wire trace rotation technique for mitigating within differential pair skew for a differential stripline pair;

FIG. 3 is an example block diagram of an artificial neural network (ANN) that generates a skew factor, given characteristic inputs of a differential stripline pair and PCB design, in accordance with one illustrative embodiment;

FIGS. 4A and 4B illustrate example cross-sections of worst case scenario orthogonally oriented differential stripline pairs relative to a glass weave;

FIG. 5 illustrates a summary of properties of modeled PCB/differential stripline pair structures in accordance with one illustrative embodiment in which five different PCB/differential stripline pair structures are modeled;

FIG. 6 illustrates an example of skew factors obtained for the plurality of structures shown in FIG. 5 from the 3D EM modeling;

FIG. 7 illustrates a comparison of the skew factor value predictions generated by both the 3D EM modeling simulation and the ANN based prediction of the illustrative embodiments;

FIG. 8 is an example block diagram of a distributed data processing system in which aspects of the illustrative embodiments may be implemented;

FIG. 9 is an example block diagram of a computing device in which aspects of the illustrative embodiments may be implemented;

FIG. 10 is a flowchart outlining an example operation for predicting a skew factor for communication channel design in accordance with one illustrative embodiment; and

FIG. 11 is a flow diagram of a design process used in semiconductor design, manufacture, and/or test in which aspects of the illustrative embodiments may be employed to assist with the design process.

### DETAILED DESCRIPTION

As noted above, one of the important factors that influences within-differential-pair-skew in striplines of a differential pair is the dielectric surrounding heterogeneity caused by glass weaves in Printed Circuit board (PCB) laminates. Commonly, PCB laminate layers are made of glass-epoxy resin composites in which the glass weaves are bound together, surrounded, and impregnated by resins to compose the dielectric filling between copper layers of multilayer PCB laminates.

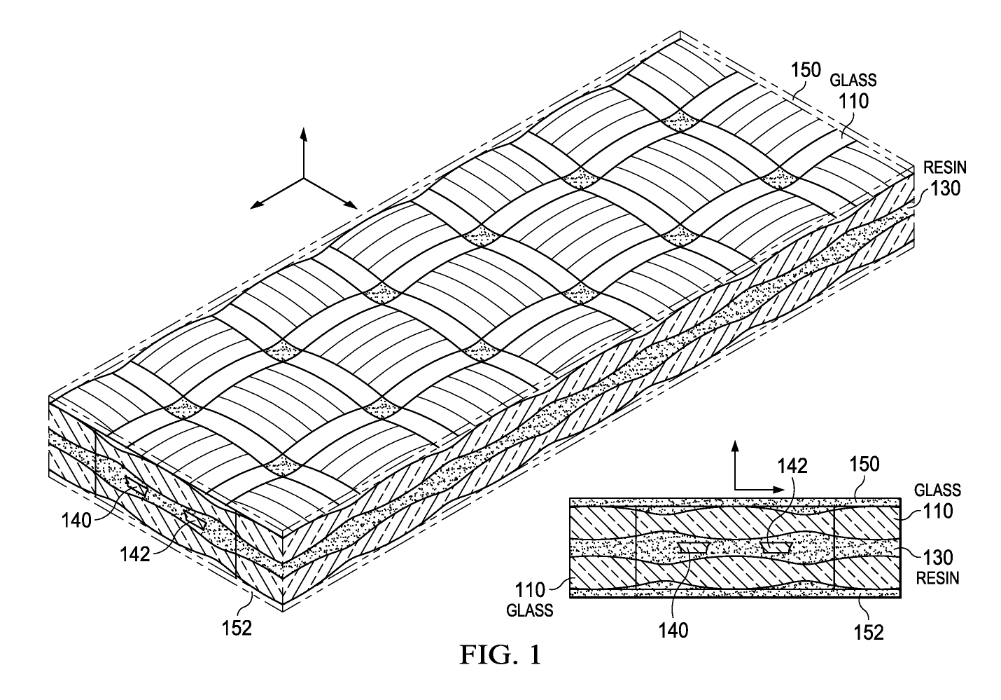

FIG. 1 is an example diagram illustrating a differential stripline pair comprising wire traces 140, 142 embedded between two ground layers 110 and surrounded by dielectric 130. The glass weaves within the dielectric (resin) 130 are clearly shown in FIG. 1 as elements 110. The dielectric constants of the glass weave 110 and resin 130 are usually different in this configuration. Moreover, the space occupied by glass weave 110 in the vertical direction can change relative to the planar position with areas of larger or less glass density. Looking at these facts in relation to the differential stripline pair 140, 142, it can be concluded that depending on the position of the wire traces 140, 142 relative to the glass weave 110, the dimensions of the glass weave 110, the dielectric properties of the resin 130 and glass 110, and the dimensions of the PCB laminate layers 150, 152, different propagation delays may be seen on each of the wire traces 140, 142 leading to skew.

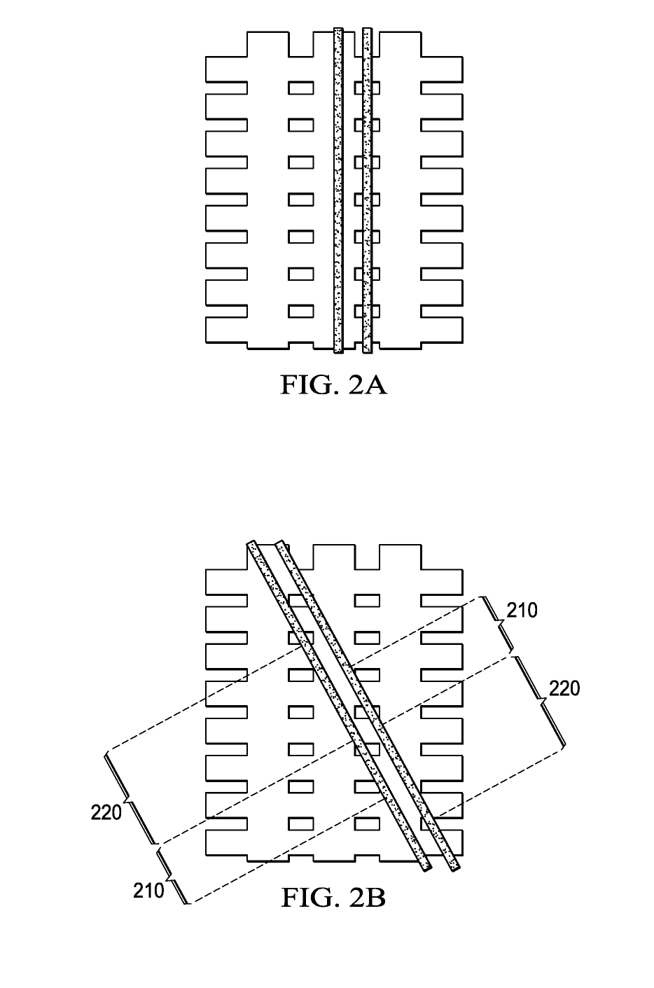

In practice, glass weave skew has been mitigated in several ways during PCB design. One mitigation technique uses wire trace rotation relative to the glass weave orthogonal grid. In this technique, each stripline of the differential pair is configured to pass over both relatively low density and high density glass regions of the glass weave, thereby balancing out the total propagation delay seen by each wire trace for a long enough section of wiring. FIG. 2B shows an illustration of the wire trace rotation technique, while FIG. 2A shows an example of a worst case orthogonal orientation of a differential stripline pair.

As shown in FIG. 2A, orienting the differential stripline pair orthogonally with the lattice of the glass weave, which can lead to wires of a stripline pair being oriented along areas where there are glass rich regions, i.e. high density glass regions, and other wires of the stripline pairs being oriented along areas where there are glass poor regions, i.e. low density glass regions. This leads to greater differential in the propagation delays along the wires of the differential stripline pair, as noted above.

However, as shown in FIG. 2B, by rotating the orientation of the wire trace such that each wire of the differential stripline pair crosses both glass rich regions and glass poor regions, a balancing of the effects of the surrounding materials of the glass weave, resin, etc. may be accomplished and thereby reduce these effects on the propagation delays of the wires in the differential stripline pair and thus, reduce skew. For example, as shown in FIG. 2B first areas 210 on the two striplines will have matching propagation delays. Similarly, second areas 220 will also have matching propagation delays to each other. Because of this configuration and the matching propagation delays, the total skew within the differential pair will balance out for a long enough differential pair, when the striplines are wired diagonally as opposed to being wired orthogonally relative to the glass weave.

In order to utilize wire trace rotation effectively, it would be very beneficial to know the amount of skew mitigation by wire trace rotation needed for a particular PCB physical design. Moreover, being able to know how much skew needs to be mitigated is helpful when making any design decisions for a PCB, regardless of which particular skew mitigation technique is selected. This would help for planning reasons, especially if many design constraints are placed on the design. Moreover, knowing the amount of skew mitigation needed may influence which skew mitigation techniques are utilized for a particular design as well as provide information to assist in design decisions that are directed to conserving space or reducing costs.

In order to quantify the need, the anticipated worst case skew factor, which is a function of PCB physical dimensions and material properties, glass weave type and differential pair dimensions, must be known. The worst case skew factor is a number in time per distance units (typically ps/inch) describing the worst case skew which a differential pair may have. Using three-dimensional (3D) electromagnetic (EM) solvers to model PCB configurations and calculate the skew factor is highly accurate, but also is a time consuming and effort intensive process. Thus, a faster and less effort intensive process, which provides accurate results, would be highly beneficial.

The illustrative embodiments provide mechanisms for implementing an artificial neural network (ANN) to estimate/predict the worst case skew for a given set of PCB and stripline dimensional and material parameters. The estimated/predicted worst case skew may then be utilized to modify a design of the PCB, and in particular the design of a high speed communication channel or bus of the PCB, based on this worst case skew and PCB design constraints, such as a required data rate of the high speed communication channel/bus, skew tolerance of the receiver(s) coupled to the high speed communication channel/bus, and the like. In particular, the design may be modified to minimize the estimated/predicted worst case skew using a minimization technique, such as wire trace rotation, glass weave rotation, dielectric property matching between the glass weave and resin of the PCB, or the like.

ANNs are generally known in the art as machine learning models which mimic biological nervous systems, and in particular the neurons of the human brain, to emulate biological learning processes. An ANN is configured as a plurality of layers of artificial neurons, or nodes, which operate on the outputs of other neurons with which they are connected. Neurons or nodes closer to the output of the ANN use the sum of the outputs from the neurons of a previous layer. Thus, in the case of an ANN having an input layer, a middle or hidden layer, and an output layer, the input layer obtains the inputs from outside the neural network, provides those inputs to each of the nodes of the hidden layer which apply weight values to these inputs from the input layer and combines these weighted inputs using a desired activation function correlating the inputs with an output. The middle or hidden layer nodes compare their generated output to a threshold, and if the threshold condition is met, transmit their output to the nodes of the next layer in the ANN, which may be an output layer or another middle or hidden layer depending on the architecture.

Initially, the weight values associated with the inputs to the nodes of the layers may be randomly assigned. A process of feedback, also referred to as backpropagation, is used to train the ANN by adjusting the weight values based on the determined difference between the actual output of the ANN and the expected or correct output that should be achieved. The backpropagation process is based on the concept that when one knows the errors of the outermost layer, e.g., the output layer, the errors in the previous layer, e.g., hidden layer, may be computed based on the weights between the two layers. In other words, the backpropagation determines how much each hidden layer node contributes to the error in the output layer and adjusts the weight of the hidden layer node accordingly. This process is repeated for each input of a training data set to thereby train the ANN to generate correct outputs given a set of inputs.

In one illustrative embodiment, a two layer feedforward artificial neural network (ANN) is implemented with a Bayesian regularization training algorithm being used to train the weight values associated with the hidden layer nodes of the two layer feedforward ANN. The Bayesian regularization training algorithm is a network training function that updates the weight and bias values according to Levenberg-Marquardt optimization, also referred to as the damped least squares (DLS) methodology.

The two layer feedforward ANN includes one input layer, one middle or hidden layer, and one output layer. In one illustrative embodiment, the input layer includes 45 input nodes where each node receives a different input parameter representing a characteristic of the differential pair dimensions and surrounding material and glass weave properties around the differential pair. For example, some of the characteristics input via the input layer include, but are not limited to, stripline trace-width, differential stripline in-pair spacing, stripline trace etc-angle, glass weave bundle periodicity, dielectric properties of glass weave and resin, glass weave and resin physical dimensions, and the like. In this illustrative embodiment, the middle or hidden layer comprises 12 nodes and the output layer comprises a single output node that provides as an output the predicted skew factor for a differential pair having the provided input characteristics. The middle or hidden layer nodes utilize a sigmoid activation function to relate the inputs to an output of the hidden layer node. The output node outputs the skew factor which describes the predicted skew associated with the differential stripline pair given the characteristics of the differential stripline pair and the PCB build, and is provided in unit of time per distance, e.g., ps/inch.

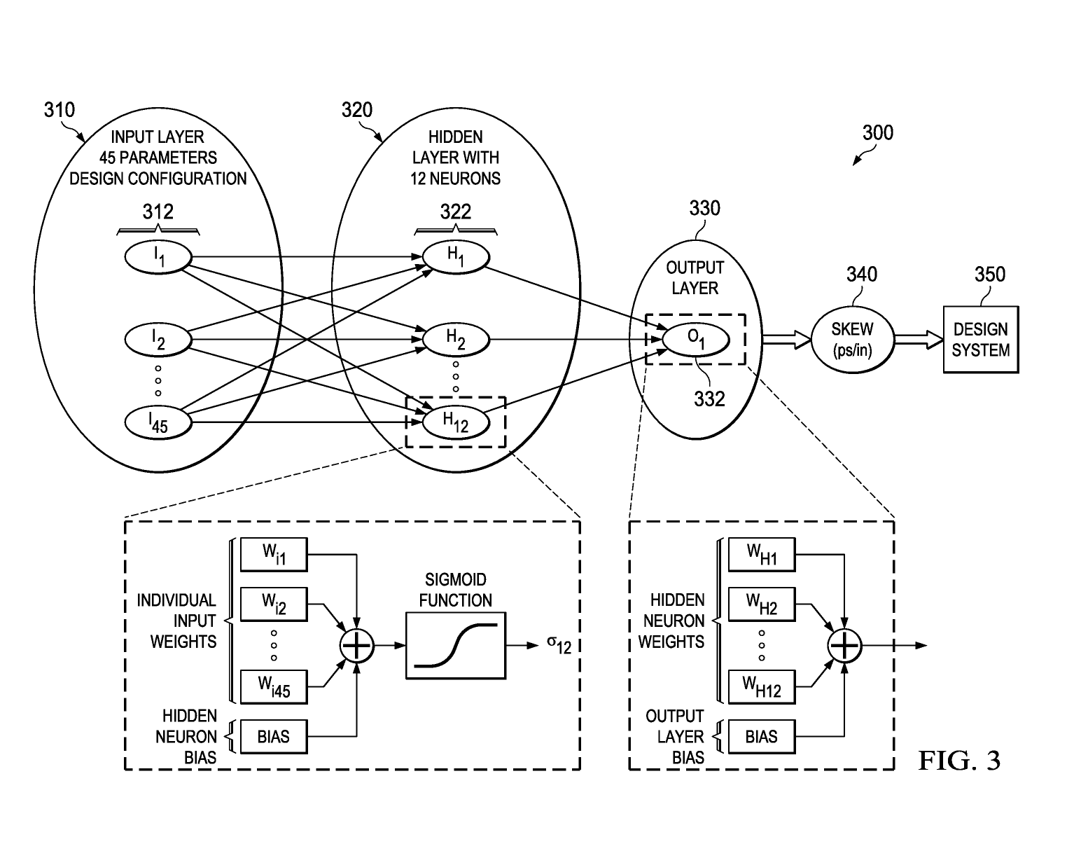

FIG. 3 is an example block diagram of an artificial neural network (ANN) that generates a skew factor, given characteristic inputs of a differential stripline pair and PCB design, in accordance with one illustrative embodiment. It should be noted that FIG. 3 shows only one possible implementation of an ANN for generating a predicted skew factor for a given differential stripline pair and PCB design. Many modifications to the depicted ANN 300 may be made without departing from the spirit and scope of the present invention. For example, the number of nodes in each of the layers 310-330 may be modified such that more or less nodes are utilized. As an example, in some implementations additional input characteristics of the differential stripline pair and PCB design may be utilized which would increase the number of input nodes in the input layer 310 as well as nodes in the hidden layer 320. Additional hidden layers may also be utilized in some implementations. In some cases, additional output nodes may be implemented that output different skew factors. Any configuration of an ANN may be utilized, depending on the desired implementation, without departing from the spirit and scope of the present invention.

As shown in FIG. 3, the input layer 310 comprises 45 input nodes 312 which each receive as input a separate design characteristic of the differential stripline pair or the printed circuit board (PCB). In particular, characteristics directed to the PCB include characteristics regarding the materials surrounding the differential stripline pair. The inputs to the input nodes 312 which are then provided to the middle layer 320 are designated I₁-I₄₅ in this example.

Each of the input nodes 312 are connected to each of the middle layer 320 nodes 322 and thus, provide their inputs I₁-I₄₅ to each of the middle layer nodes 322. In the depicted example, there are 12 middle layer, or hidden layer, nodes 322 in the middle or hidden layer 320. The middle layer nodes 322 each apply their own learned weight values, designated Wᵢ₁-Wᵢ₄₅ to the inputs I₁-I₄₅ received from the input layer nodes 312. The weights Wᵢ₁-Wᵢ₄₅ may initially be set to random values, but the correct value for each weight Wᵢ₁-Wᵢ₄₅ is learned through a training process and the use of a backpropagation feedback technique for adjusting the weights Wᵢ₁-Wᵢ₄₅ until they provide an accurate output at the output layer 330.

As shown in FIG. 3, the middle layer nodes combine the weighted inputs, and optionally a bias which may also be learned through the training process, via a sigmoid function that generates an output value σ, such that there are 12 outputs σ₁ to σ₁₂. These outputs σ₁ to σ₁₂ are input to the output layer 330 node 332 which applies its own learned weight values W_{H1} to W_{H12}, and optionally a bias which may also be learned through the training process, and combines them using a function that calculates a skew factor 340 based on the weighted inputs. The training algorithm (e.g., Bayesian Regularization) assigns weights to the output value from each node and updates iteratively till the cost function (of the optimization problem) is minimized. As long as the inputs are given while maintaining constant units, the units themselves are less important as the algorithm will treat the values of the inputs and their relative variations of magnitude.

The skew factor 340 is provided as an output to a design system 350 which generates or modifies a design based on the predicted skew factor 340. In some cases, the design system 350 may generate various design constraints based on the predicted skew factor 340 and may present these design constraints to a designer to assist them in determining how to modify a design of the PCB to take into account an amount of skew factor that needs to be mitigated. The amount of skew factor that needs to be mitigated may be determined based on an already established design constraint of a skew tolerance for the differential stripline pair of the communication channel in comparison with the predicted skew factor, e.g., the design constraint may be a skew tolerance of 10 ps and the skew factor indicates a skew factor of 5 ps/inch. This gives a maximum wire length of 2 inches in order to be within the skew tolerance. However, if a wire length of 3 inches is needed, then the skew factor must be reduced to approximately 3.33 ps/inch. As a result, a skew mitigation technique may be introduced to reduce the skew factor by either performing wire trace rotation whose degree of rotation is determined based on the amount of skew factor reduction needed, performing glass weave rotation with a similar amount of rotation being calculated based on the amount of skew factor reduction needed, modifying the dielectric properties of the materials surrounding the differential stripline pair, or the like.

The particular skew mitigation technique implemented, as well as the amount of any skew mitigation, may depend on the overall circuit layout or board wiring and, in general, is determined on a case by case basis. As one possible example, assume that there is a skew budget of 15 picosecond (ps). Also assume that the worst case skew is predicted to be 3 ps/in. Under these circumstances, the maximum orthogonal wiring that can be allowed is 15/3=5 inches. Beyond this length, all routing has to be done diagonally to offset glass weave induced skew. Thus, in the PCB design, any communication channels or buses that are beyond 5 inches in length, will need to be redesigned from an orthogonal configuration to a diagonally oriented configuration relative to the glass weave so as to reduce the skew. The amount of the diagonal orientation will be dependent upon how much skew must be mitigated, which is dependent upon the length of the actual communication channel or bus being utilized in the PCB design.

These mitigation techniques may be automatically implemented by the design system 350, semi-automatically implemented by the design system 350 with human user intervention to verify or approve design decisions with the assistance of the design system 350 providing suggested modifications to the design, or may be performed manually by the human designer based on outputs generated by the design system 350 to inform the designer of the skew factor reduction needed, for example. In one example, a PCB design tool, such as Cadence Allegro for example, may incorporate the skew predicting tool to obtain feedback on the skew in real-time while designing a particular PCB with known laminated board structure and electrical properties.

As noted above, in order to implement an ANN 300 to predict the skew factor for a given set of input characteristics of a differential stripline pair and PCB, the ANN 300 must be trained such that correct weight values are applied at the hidden and output layers of the ANN 300. In one illustrative embodiment, a set of training data and test data is generating using three dimensional electromagnetic (3D EM) modeling to generate correct skew factor information for a given design. Multiple different structures are modeled using the 3D EM modeling where the structures represent a differential stripline pair within a dielectric PCB layer placed in an orthogonally routed worst case position relative to the glass weave bundles, e.g., similar to the orientation shown in FIG. 2A.

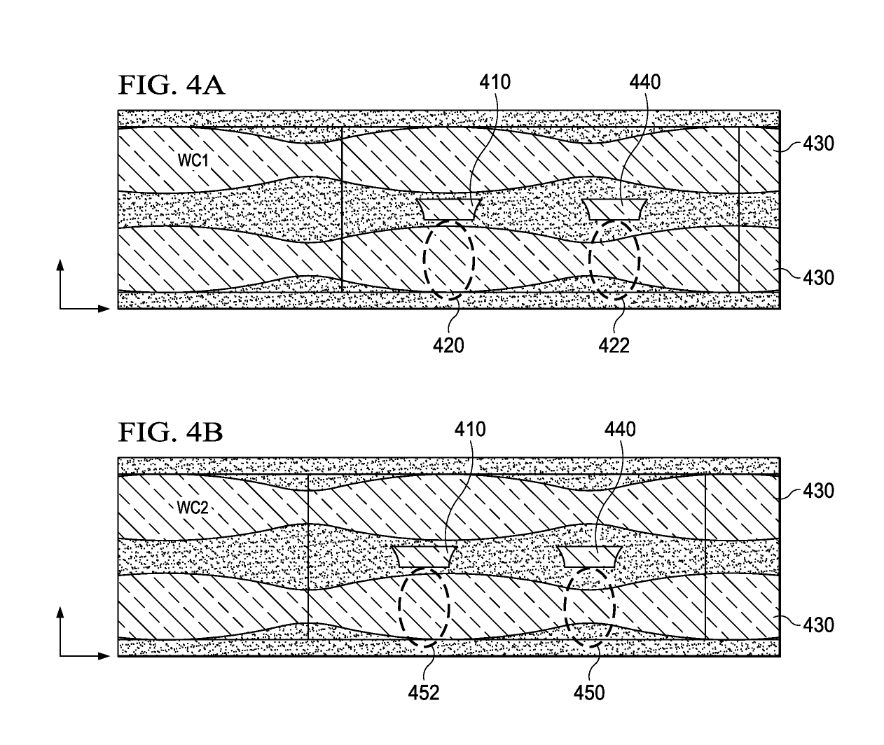

As shown in FIGS. 4A and 4B, there are two different worst case scenarios for orthogonally oriented differential stripline pairs routed in an internal PCB layer, where again the orthogonal orientation is relative to the glass weave. The first worst case scenario occurs when one of the wire lines of the differential stripline pair is routed over the glass richest region, i.e. the regions where there is relatively high glass density, as in the case of wire line 410 in FIG. 4A. As shown in FIG. 4A, the wire line 410 is oriented orthogonally with respect to the highest density portion 420 of the glass weave 430 while the wire line 440 is oriented in close proximity over a less dense portion 422 of the glass weave 430.

The second worst case scenario occurs when one of the wire lines of the differential stripline pair is routed over the glass lowest region, i.e. the regions where there is relatively low glass density, as in the case of wire line 440 in FIG. 4B. As shown in FIG. 4B, the wire line 440 is oriented orthogonally with respect to the lowest density portion 450 of the glass weave 430 while the wire line 410 is oriented in close proximity over a relatively more dense portion 452 of the glass weave 430.

In either of these worst case scenarios, the difference in the densities of the glass and resin materials in these portions 420 and 450 of the glass weave 430 with regard to the portions 422 and 452, respectively, causes worst case skew in the wire lines of the differential stripline pair. These worst case scenarios are referred to herein a WC1 and WC2, respectively. The 3D EM modeling performed to generate the training and test inputs for training the ANN 300 models both worst case scenarios WC1 and WC2 for multiple different PCB and differential stripline pair builds.

In one illustrative embodiment, five different PCB and differential stripline pair builds are utilized to generate training and test inputs for training the ANN 300, resulting in approximately 120 data points. It should be appreciated that this is only an example, and more or less data points may be utilized, as well as more or less PCB and differential stripline pair builds may be modeled, without departing from the spirit and scope of the present invention. Each structure, or build, modeled has different stack up thicknesses, glass weave combinations, and material family type. For each PCB build, multiple differential impedance stripline dimensions are modeled, i.e. different line widths and in-pair spacing combinations leading to the same impedance, e.g., the same 85 Ohm impedance.

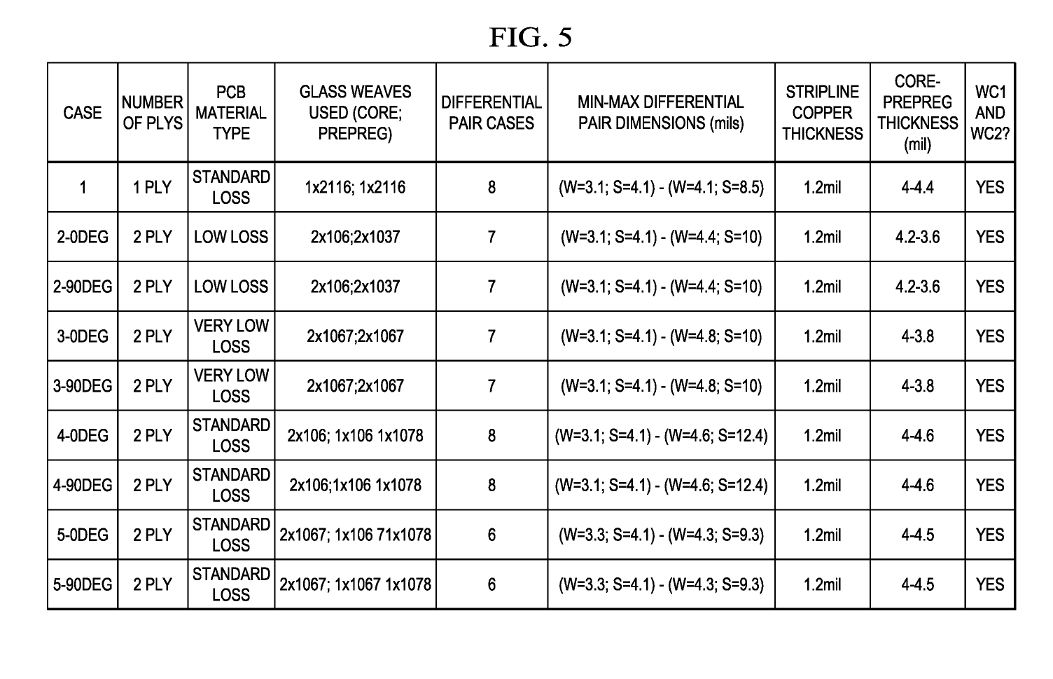

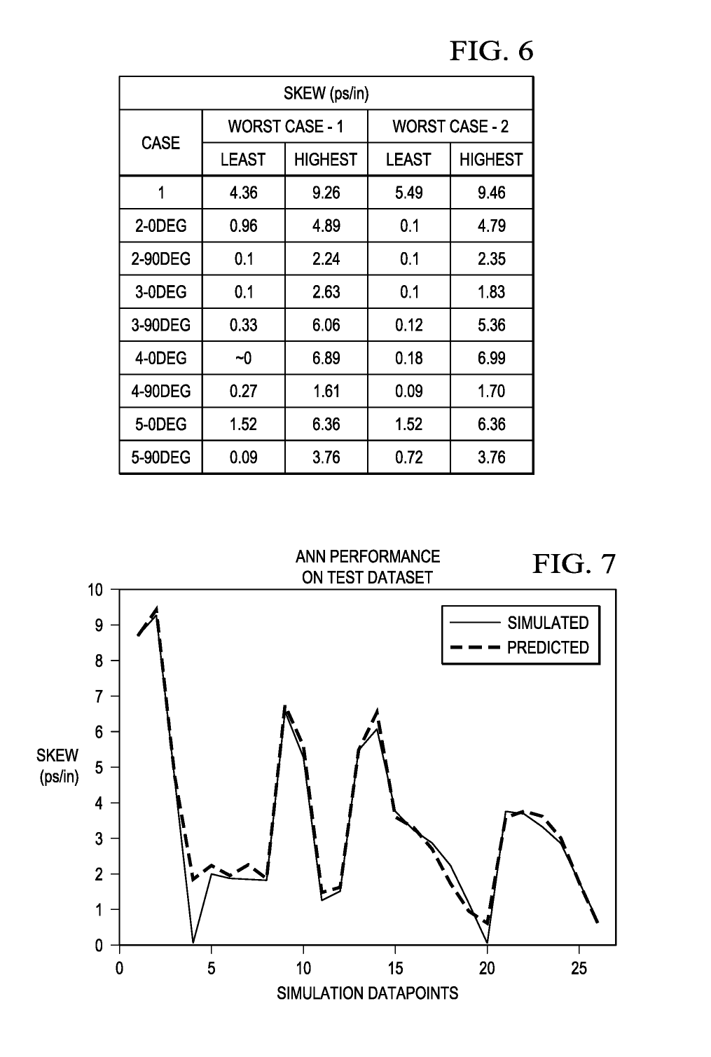

It should be noted that many glass weaves do not have a square grid or lattice and as a result, routing orthogonally in one direction can lead to different worst case skews than the other perpendicular direction. These two directions are known as glass weave warp and weft directions. In order to address this possibility, when modeling the PCB build using the 3D EM modeling mechanisms, both directions of glass weave warp and weft are considered. Hereafter, the glass weave warp and weft directions will be referred to herein and in the figures as the 0 deg and 90 deg directions. FIG. 5 illustrates a summary of properties of modeled PCB/differential stripline pair structures in accordance with one illustrative embodiment in which five different PCB/differential stripline pair structures are modeled. In case 1 of FIG. 5, as well as in FIG. 6 described hereafter, it should be appreciated that a symmetrical structure is utilized such that there is equal warp and weft periodicities, meaning that the 90° rotation will generate the same structure. A point to note here is that the 0° and 90° rotations are effectively two new structures when the glass weave fibers have different periodicities along warp and weft directions. So these are separate datapoints for the ANN and for all practical purposes, as the skew observed along these two orthogonal directions would be different.

FIG. 5 illustrates just some of the properties of the PCB/differential stripline pair structure that are used by the 3D EM modeling mechanisms to model the structure and generate a simulation of the operational characteristics of the structure, including a skew factor. The actual 3D EM modeling mechanism itself is generally known in the art and thus, the details of how the 3D EM modeling mechanism models the PCB builds will not be presented herein. However, it should be appreciated that the illustrative embodiments utilize these mechanisms in a specific manner to generate the training and testing data sets specifically for the identified worst case scenarios indicated above, and specifically for the two possible orthogonal orientations of the glass weave warp (0 deg) and glass weave weft (90 deg) directions. Moreover this specific implementation of the 3D EM modeling performed for worst case scenarios and glass weave orientation directions (0 deg and 90 deg) is further performed for multiple potential PCB/differential stripline pair structures so as to provide a plurality of different data points for generating training and testing data.

For each of these combinations of structure, worst case scenario, and glass weave orientation direction, a skew factor is calculated using differential time domain transmissometry (TDT). TDT is a technique that measures the transmitted impulse and is an analogous technique to time domain reflectometry (TDR) used to determine the characteristics of electrical lines by observing waveforms. In each case, the minimum and maximum skew factor generated by the TDT based modeling is output by the 3D EM modeling mechanisms and this information, along with the corresponding PCB and differential stripline pair characteristics, are fed into the ANN 300 as input.

FIG. 6 illustrates an example of skew factors obtained for the plurality of structures shown in FIG. 5 from the 3D EM modeling. As shown in FIG. 6, for each PCB/differential stripline pair structure, also referred to as a “case” in FIG. 6, a minimum (least) and maximum (highest) skew factor for each worst case scenario (WC1 and WC2) is generated for each glass weave orientation direction (0 deg and 90 deg). From FIG. 6 it can be seen that there is a wide range of skew factors for each of the various structures. The minimum and maximum skews factors for a particular worst cases (WC1 and WC2) for each of the cases corresponds to the minimum and maximum obtained among the different impedance pair dimensions that were modeled.

Each of the skew factors generated by the 3D EM modeling mechanisms, such as those shown in FIG. 6, are correlated with input characteristics of the corresponding structures to thereby generate data sets for each structure, e.g., 45 input characteristics and 1 output skew factor. These represent the “golden set” of data that may be used for training and testing. The golden set is divided into a neural network training dataset and a neural network blind testing dataset.

For example, in one illustrative embodiment, for testing the neural network two data points from each of the structure cases are selected in addition to all of the “case 5” 90 deg data points. In this example implementation, “case 5” is kept as a totally blind set to check the performance of the ANN on a structure it has not previously been exposed to during the training phase. The other test points are randomly selected to ensure that no bias creeps into the training of the skew predictor mechanisms. Of course any desirable division of the 3D EM modeling mechanism outputs in the golden set may be used, depending on the desired implementation, without departing from the spirit and scope of the present invention.

The neural network training dataset is input iteratively into the ANN 300 to thereby train the ANN 300 in the manner previously described above. That is, weight values are randomly assigned to nodes, e.g., hidden or middle layer nodes 322 and output layer node(s) 332, and an initial set of input data values are input to the ANN 300 and an output predicted skew factor is generated. This output predicted skew factor is compared to the actual skew factor calculated by the 3D EM modeling mechanism to determine an amount of error. This error is then backpropagated through the ANN 300 to adjust the weight values applied by the various nodes 322 and 332. A next set of input data values and corresponding actual skew factor are used to perform a next iteration of the training by performing a similar evaluation and backpropagation. In this way, the weight values are iteratively adjusted such that the ANN 300 makes better predictions of skew factor with each iteration.

Once the ANN 300 is trained, the ANN 300 is tested using the neural network blind testing dataset. Again, during testing the performance of the ANN 300 is evaluated and a determination is made as to whether additional adjustment of the weight values is needed. That is, an unknown “blind” test dataset is used to check/validate the performance of the skew prediction for practical applications. So since there is a limited number of data points from the simulations, the testing dataset is maintained separate to allow for rigorous validation after initial training. Only the skew prediction values of the training dataset are seen by the optimization algorithm, so that it can assign the best weight values which generate correct skew predictions from the training dataset.

Once the ANN 300 is trained and tested, it may be implemented for evaluating other cases where the 3D EM modeling is not utilized to predict skew factor. A significant benefit is that the ANN 300 takes considerably less time and effort to implement and obtain the desired skew factor prediction than using a 3D EM modeling mechanism. For example, using 3D EM modeling and simulation may take many hours or even days to generate a skew factor prediction whereas the ANN based mechanisms of the illustrative embodiments may take a matter of seconds to generate a skew factor prediction. This greatly improves the time needed to generate a design of a PCB structure as many factors of the PCB design may be dependent upon the prediction of skew factor.

Moreover, the illustrative embodiments implementing an ANN based mechanism for generating a skew factor prediction generates accurate results similar to that of the 3D EM modeling. FIG. 7 illustrates a comparison of the skew factor value predictions generated by both the 3D EM modeling simulation and the ANN based prediction of the illustrative embodiments. As shown in FIG. 7, the majority of skew factor predictions match the skew factors calculated as part of the more time intensive 3D EM modeling simulation for each number of simulation datapoints. The only outlier is at datapoint 4. These results are achieved in a negligible amount of time when compared to a 3D EM modeling simulation and with significantly less expenditure of human resources.

It should be appreciated that an additional benefit of the ANN based mechanisms of the illustrative embodiments is that the accurate prediction of skew factor for an input PCB/differential stripline pair structure or build is achieved with a relatively small training and testing data set, e.g., only 120 datapoints in one illustrative embodiment. Thus, training and testing of the ANN based mechanisms of the illustrative embodiments requires a relatively small expenditure of time and resources when compared to more complex 3D EM modeling mechanisms. It should also be recognized that even more accurate results may be obtained in implementations of the illustrative embodiments where larger sets of training data points which are well distributed are utilized.

It should be appreciated that throughout this description the term “mechanism” is used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” as used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the present description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

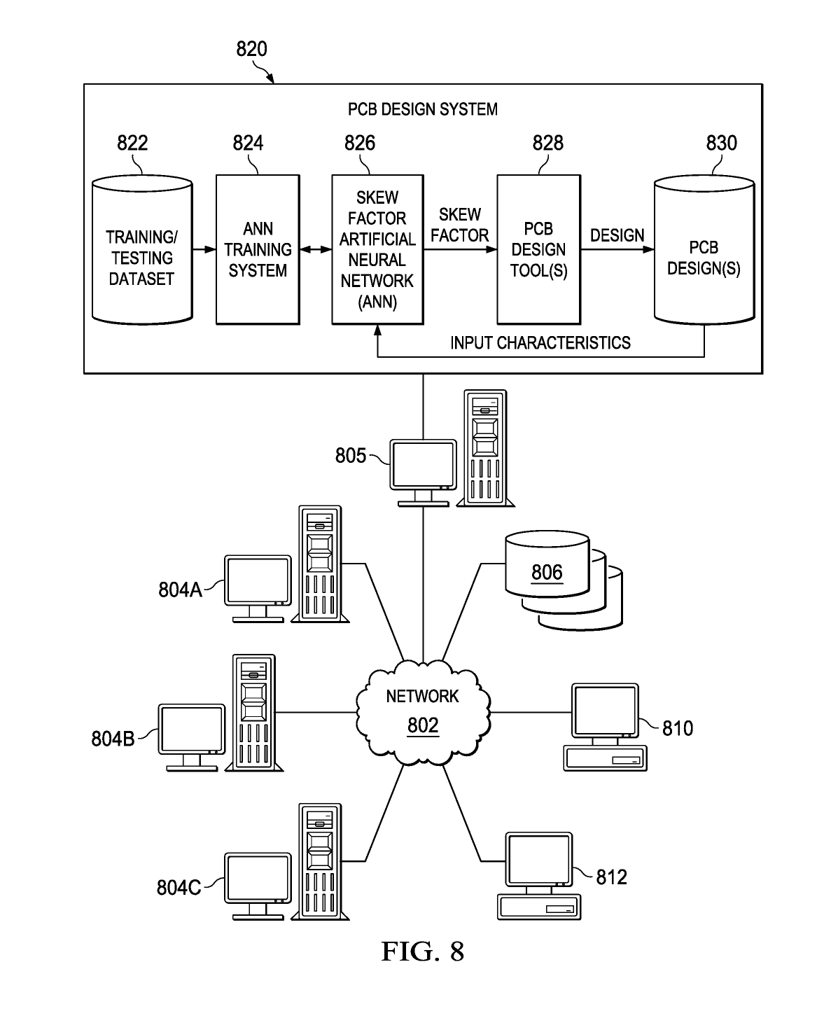

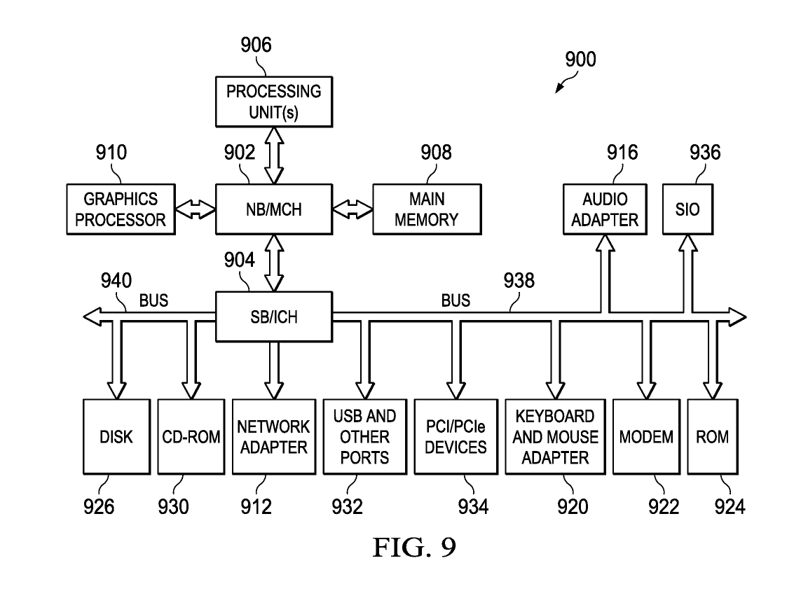

The illustrative embodiments may be utilized in many different types of data processing environments. In order to provide a context for the description of the specific elements and functionality of the illustrative embodiments, FIGS. 8-9 are provided hereafter as example environments in which aspects of the illustrative embodiments may be implemented. It should be appreciated that FIGS. 8-9 are only examples and are not intended to assert or imply any limitation with regard to the environments in which aspects or embodiments of the present invention may be implemented. Many modifications to the depicted environments may be made without departing from the spirit and scope of the present invention.

FIG. 8 depicts a pictorial representation of an example distributed data processing system in which aspects of the illustrative embodiments may be implemented. Distributed data processing system 800 may include a network of computers 804A-804B, 805, and 810-812, in which aspects of the illustrative embodiments may be implemented in one or more of these computers. The distributed data processing system 800 contains at least one network 802, which is the medium used to provide communication links between various devices and computers connected together within distributed data processing system 800. The network 802 may include connections, such as wire, wireless communication links, or fiber optic cables.

In the depicted example, servers 804A-804C and server 805 are connected to network 802 along with storage system 806. In addition, clients computers (or simply “clients”) 810 and 812 are also connected to network 802. These clients 810 and 812 may be, for example, personal computers, network computers, or the like. In the depicted example, servers 804A-804C and 805 may provide data, such as boot files, operating system images, and applications, as well as data structures to the clients 810 and 812. Clients computers 810 and 812 are clients to one or more of servers 804A-804C, and 805 in the depicted example. Distributed data processing system 800 may include additional servers, clients, and other devices not shown.

In the depicted example, distributed data processing system 800 is the Internet with network 802 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 800 may also be implemented to include a number of different types of networks, such as for example, an intranet, a local area network (LAN), a wide area network (WAN), or the like. As stated above, FIG. 8 is intended as an example, not as an architectural limitation for different embodiments of the present invention, and therefore, the particular elements shown in FIG. 8 should not be considered limiting with regard to the environments in which the illustrative embodiments of the present invention may be implemented.

As shown in FIG. 8, one or more of the computing devices, e.g., server 105, may be specifically configured to implement a printed circuit board (PCB) design system 820. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 805, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates PCB design and in particular, elements of PCB design that are dependent upon the prediction of a skew factor associated with a communication channel, e.g., bus, of the PCB design.

As shown in FIG. 8, the PCB design system 820 comprises a skew factor artificial neural network (ANN) 826 which is trained by ANN training system 824 based on training/testing dataset 822. The PCB design system 820 further comprises one or more PCB design tool(s) 828 and PCB design storage system 830. The skew factor ANN 826 may be configured and operate in a manner similar to one or more of the illustrative embodiments described above, such as the ANN 300 in FIG. 3. The skew factor ANN 826 is trained by the ANN training system 824 which applies inputs from the training/testing dataset 822 and determines errors in outputs based on the skew factors associated with the training/testing dataset 822. Based on the calculated error, the weights associated with nodes of the skew factor ANN 826 are adjusted and the process is repeated with another set of inputs and corresponding skew factor from the training/testing dataset 822. This process is iteratively performed until training of the skew factor ANN 826 is determined to be complete. At this point, the ANN training system 824 may test the operation of the skew factor ANN 826 to ensure proper operation using the test dataset in the training/testing dataset 822. If good results are achieved, then the skew factor ANN 826 may be deployed for runtime operation with the PCB design tool(s) 828 and PCB design(s) 830. Otherwise, if good results are not achieved, additional training/testing may be performed by the ANN training system 824.

As discussed above, the training/testing dataset 822 may be generated in any suitable manner with one illustrative embodiment being the modeling and simulation of a set of different PCB/differential stripline pair structures to generate simulated skew factors for combinations of worst case scenarios, e.g., WC1 and WC2, for different glass weave orientation directions, e.g., 0 deg and 90 deg. The number of structures modeled and simulated is implementation dependent as is the number of worst case scenarios considered. The training/testing dataset 822 may be divided into separate training and testing datasets in accordance with any desired implementation.

Once deployed for runtime operation, the skew factor ANN 826 may be provided, as input, various input characteristics about a PCB/differential stripline pair structure which are then processed by the skew factor ANN 826 to output a predicted skew factor for the structure. For example, a user, such as a user of a client computer 810 or 812, may interact with PCB design tool(s0 828 to define a PCB/differential stripline pair structure which is stored in the PCB design(s) storage system 830. The users may also request, via the PCB design tool(s) 828, the operation of the skew factor ANN 826 to determine a prediction of the skew factor for the particular structure. The skew factor ANN 826 may operate on the input characteristics, such as the 45 input characteristics mentioned above with regard to one illustrative embodiment, and generate a predicted skew factor without having to perform a complete 3D EM simulation of the PCB/differential stripline pair structure, and in a negligible amount of time.

The skew factor is provided to the PCB design tool(s) 828 which may perform operations to facilitate making design decisions regarding the PCB/differential stripline pair structure. In one illustrative embodiment, the PCB design tool(s) 828 (e.g., PCB design tools such as Cadence-Allegro, Mentorgraphics RF Design, NI RF PCB, Electronics Workbench, Altium Designer, or the like) may simply output an indication of the predicted skew factor for the structure. In other illustrative embodiments, the PCB design tool(s) 828 may be augmented to calculate constraints of the PCB design that are determined based on the predicted skew factor, e.g., maximum orthogonally oriented wire length of the differential stripline pair, a communication channel or bus budget margin, or the like. For example, a bus will have an associated budget for maximum delay in between its constituent lanes. This is the group delay budget, which needs to be met to ensure that all the lanes are able to synchronize with the bus clock. This budget generally incorporates all the sources of delays including the skew factor. The glass weave skew factor will also determine how much length correction must be done in between different lanes of a bus to meet the bus group skew budget.

In other illustrative embodiments, the PCB design tool(s) 828 may automatically or semi-automatically perform skew mitigation operations for mitigating predicted skew based on design constraints. These mitigation operations may also be initiated manually by a designer in response to notification of the predicted skew factor, for example. The mitigation operations may involve, for example, one or more of a wire trace rotation mitigation operation, a glass weave rotation mitigation operation, a glass weave/resin characteristics balancing mitigation operation, or any other operation for modifying the PCB design either in orientation of the wires or glass weave, changing dielectric properties of the structure around the differential stripline pair, or the like, that attempts to mitigate excessive skew in the differential stripline pair of the communication channel or bus. The PCB design tool(s) 828 may store any modified or updated PCB design in the PCB design storage system 830.

As noted above, the mechanisms of the illustrative embodiments utilize specifically configured computing devices, or data processing systems, to perform the operations for predicting skew factor for communication channels of a PCB design and thereby modify or inform design decisions made, either manually, automatically, or semi-automatically, regarding the overall PCB design. These computing devices, or data processing systems, may comprise various hardware elements which are specifically configured, either through hardware configuration, software configuration, or a combination of hardware and software configuration, to implement one or more of the systems/subsystems described herein. FIG. 9 is a block diagram of just one example data processing system in which aspects of the illustrative embodiments may be implemented. Data processing system 900 is an example of a computer, such as server 805 in FIG. 8, in which computer usable code or instructions implementing the processes and aspects of the illustrative embodiments of the present invention may be located and/or executed so as to achieve the operation, output, and external affects of the illustrative embodiments as described herein.

In the depicted example, data processing system 900 employs a hub architecture including north bridge and memory controller hub (NB/MCH) 902 and south bridge and input/output (I/O) controller hub (SB/ICH) 904. Processing unit 906, main memory 908, and graphics processor 910 are connected to NB/MCH 902. Graphics processor 910 may be connected to NB/MCH 902 through an accelerated graphics port (AGP).

In the depicted example, local area network (LAN) adapter 912 connects to SB/ICH 904. Audio adapter 916, keyboard and mouse adapter 920, modem 922, read only memory (ROM) 924, hard disk drive (HDD) 926, CD-ROM drive 930, universal serial bus (USB) ports and other communication ports 932, and PCI/PCIe devices 934 connect to SB/ICH 904 through bus 938 and bus 940. PCI/PCIe devices may include, for example, Ethernet adapters, add-in cards, and PC cards for notebook computers. PCI uses a card bus controller, while PCIe does not. ROM 924 may be, for example, a flash basic input/output system (BIOS).

HDD 926 and CD-ROM drive 930 connect to SB/ICH 904 through bus 940. HDD 926 and CD-ROM drive 930 may use, for example, an integrated drive electronics (IDE) or serial advanced technology attachment (SATA) interface. Super I/O (SIO) device 936 may be connected to SB/ICH 904.

An operating system runs on processing unit 906. The operating system coordinates and provides control of various components within the data processing system 900 in FIG. 9. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 900.

As a server, data processing system 900 may be, for example, an IBM eServer™ System p computer system, Power™ processor based computer system, or the like, running the Advanced Interactive Executive (AIX®) operating system or the LINUX® operating system. Data processing system 900 may be a symmetric multiprocessor (SMP) system including a plurality of processors in processing unit 906. Alternatively, a single processor system may be employed.

Instructions for the operating system, the object-oriented programming system, and applications or programs are located on storage devices, such as HDD 926, and may be loaded into main memory 908 for execution by processing unit 906. The processes for illustrative embodiments of the present invention may be performed by processing unit 906 using computer usable program code, which may be located in a memory such as, for example, main memory 908, ROM 924, or in one or more peripheral devices 926 and 930, for example.

A bus system, such as bus 938 or bus 940 as shown in FIG. 9, may be comprised of one or more buses. Of course, the bus system may be implemented using any type of communication fabric or architecture that provides for a transfer of data between different components or devices attached to the fabric or architecture. A communication unit, such as modem 922 or network adapter 912 of FIG. 9, may include one or more devices used to transmit and receive data. A memory may be, for example, main memory 908, ROM 924, or a cache such as found in NB/MCH 902 in FIG. 9.

As mentioned above, in some illustrative embodiments the mechanisms of the illustrative embodiments may be implemented as application specific hardware, firmware, or the like, application software stored in a storage device, such as HDD 926 and loaded into memory, such as main memory 908, for executed by one or more hardware processors, such as processing unit 906, or the like. As such, the computing device shown in FIG. 9 becomes specifically configured to implement the mechanisms of the illustrative embodiments and specifically configured to perform the operations and generate the outputs described herein with regard to the an ANN based skew factor prediction mechanism and PCB design system.

Those of ordinary skill in the art will appreciate that the hardware in FIGS. 8 and 9 may vary depending on the implementation. Other internal hardware or peripheral devices, such as flash memory, equivalent non-volatile memory, or optical disk drives and the like, may be used in addition to or in place of the hardware depicted in FIGS. 8 and 9. Also, the processes of the illustrative embodiments may be applied to a multiprocessor data processing system, other than the SMP system mentioned previously, without departing from the spirit and scope of the present invention.

Moreover, the data processing system 900 may take the form of any of a number of different data processing systems including client computing devices, server computing devices, a tablet computer, laptop computer, telephone or other communication device, a personal digital assistant (PDA), or the like. In some illustrative examples, data processing system 900 may be a portable computing device that is configured with flash memory to provide non-volatile memory for storing operating system files and/or user-generated data, for example. Essentially, data processing system 900 may be any known or later developed data processing system without architectural limitation.

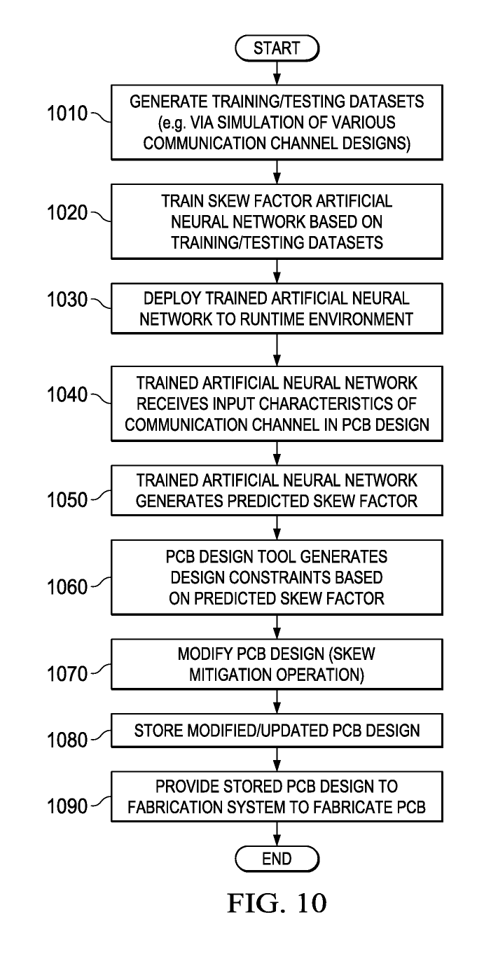

FIG. 10 is a flowchart outlining an example operation for predicting a skew factor for communication channel design in accordance with one illustrative embodiment. As shown in FIG. 10, the operation starts by generating training/testing datasets using a simulation or modeling mechanism for simulating/modeling a plurality of communication channel designs (step 1010). It should be appreciated that the term “communication channel designs” refers to any communication channel that may be part of a printed circuit board (PCB) design. In the examples described above, the communication channel is a differential stripline pair, however the principles and mechanisms of the illustrative embodiments may be applied to any communication channel of a PCB design where the characteristics of the communication channel and the surrounding structure of the PCB design may be provided as input to an artificial neural network (ANN) which generates a predicted skew factor based on these characteristics.

The training/testing datasets are used to train a skew factor ANN such that the ANN weights are adjusted until a sufficiently accurate prediction of skew factor is generated based on the input characteristics of the communication channel (step 1020). The trained ANN is then deployed in a runtime environment (step 1030) where the trained ANN receives a set of input characteristics for a communication channel of a PCB design (step 1040). The trained ANN operates on the input characteristics to generate a predicted skew factor (step 1050). The predicted skew factor is provided to a PCB design tool which determines design constraints based on the predicted skew factor (step 1060). The design constraints are then used to modify the PCB design, either manually, automatically, or semi-automatically, such as by performing a skew mitigation operation, for example (step 1070). The resulting modified or updated PCB design is stored (step 1080). The stored PCB design may then be provided to a fabrication system to fabricate the PCB in accordance with the PCB design which is at least partially based on the predicted skew factor generated by the trained ANN (step 1090). The operation then terminates.

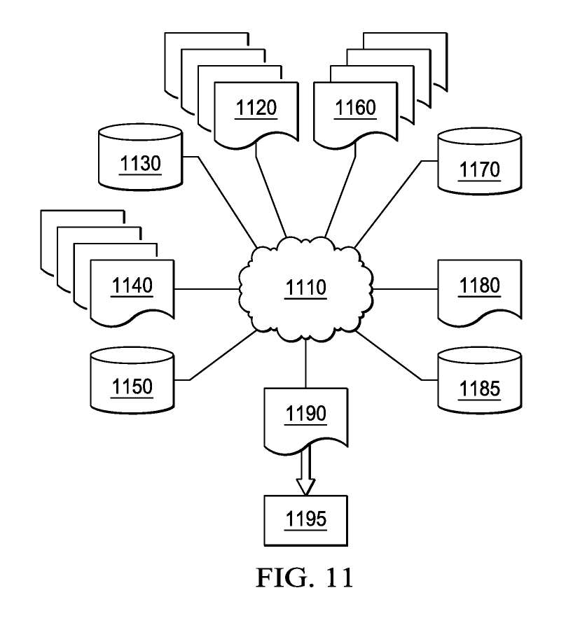

FIG. 11 shows a block diagram of an exemplary design flow 1100 used for example, in semiconductor design, manufacturing, and/or test. Design flow 1100 may vary depending on the type of IC being designed. For example, a design flow 1100 for building an application specific IC (ASIC) may differ from a design flow 1100 for designing a standard component. Design structure 1120 is preferably an input to a design process 1110 and may come from an IP provider, a core developer, or other design company or may be generated by the operator of the design flow, or from other sources. Design structure 1120 comprises PCB design, that is at least partially generated based on the predicted skew factor generated by a trained skew factor ANN in accordance with one or more of the illustrative embodiments described herein, such as the trained skew factor ANN 300 in FIG. 3 or 826 in Figure, in the form of schematics or HDL, a hardware-description language (e.g., Verilog, VHDL, C, etc.). Design structure 1120 may be contained on one or more machine readable medium. For example, design structure 1120 may be a text file or a graphical representation of a PCB design as generated using the mechanisms of one or more of the illustrative embodiments. Design process 1110 preferably synthesizes (or translates) a PCB design generated in accordance with an illustrative embodiment into a netlist 1180, where netlist 1180 is, for example, a list of wires, transistors, logic gates, control circuits, I/O, models, etc. that describes the connections to other elements and circuits in an integrated circuit design and recorded on at least one of machine readable medium. This may be an iterative process in which netlist 1180 is resynthesized one or more times depending on design specifications and parameters for the circuit.

Design process 1110 may include using a variety of inputs; for example, inputs from library elements 1130 which may house a set of commonly used elements, circuits, and devices, including models, layouts, and symbolic representations, for a given manufacturing technology (e.g., different technology nodes, 32 nm, 45 nm, 90 nm, etc.), design specifications 1140, characterization data 1150, verification data 1160, design rules 1170, and test data files 1185 (which may include test patterns and other testing information). Design process 1110 may further include, for example, standard circuit design processes such as timing analysis, verification, design rule checking, place and route operations, etc. One of ordinary skill in the art of integrated circuit design can appreciate the extent of possible electronic design automation tools and applications used in design process 1110 without deviating from the scope and spirit of the invention. The design structure of the invention is not limited to any specific design flow.

Design process 1110 preferably translates a PCB design generated in accordance with one or more of the illustrative embodiments, along with any additional integrated circuit design or data (if applicable), into a second design structure 1190. Design structure 1190 resides on a storage medium in a data format used for the exchange of layout data of integrated circuits (e.g. information stored in a GDSII (GDS2), GL1, OASIS, or any other suitable format for storing such design structures). Design structure 1190 may comprise information such as, for example, test data files, design content files, manufacturing data, layout parameters, wires, levels of metal, vias, shapes, data for routing through the manufacturing line, and any other data required by a semiconductor manufacturer to produce a PCB design generated in accordance with one or more of the illustrative embodiments. Design structure 1190 may then proceed to a stage 1195 where, for example, design structure 1190: proceeds to tape-out, is released to manufacturing, is released to a mask house, is sent to another design house, is sent back to the customer, etc.

Thus, the illustrative embodiments provide mechanism for generating a PCB design taking into consideration a predicted skew factor for at least one communication channel of the PCB design. The predicted skew factor is generated based on a trained skew factor ANN which generates the predicted skew factor rapidly without requiring a simulation of the PCB design. The trained skew factor ANN is trained based on a relatively small set of data points generated from simulations of various PCB and communication channel designs and utilizes the minimum and maximum observed skew factors for various worst case scenarios and possible glass weave orientation directions. The illustrative embodiments greatly reduce the amount of time required to generate a PCB design by reducing the time necessary to generate predicted skew factors to a negligible amount of time. Moreover, the amount of time and resources needed to generate a trained skew rate ANN is relatively small compared to full 3D EM modeling and simulation mechanisms.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising at least one processor and at least one memory, the at least one memory comprising instructions executed by the at least one processor to cause the at least one processor to implement a skew rate artificial neural network (ANN), the method comprising:
generating, by the data processing system, a training dataset for training the skew rate ANN, wherein the training dataset comprises a plurality of sets of data, and wherein each set of data corresponds to a particular set of printed circuit board (PCB) and communication channel characteristics;
training, by the data processing system, the skew rate ANN based on the training dataset to generate a trained skew rate ANN;
receiving, by the data processing system, an input dataset representing a set of PCB characteristics and communication channel characteristics for a PCB design and communication channel of the PCB design;
generating, by the trained skew rate ANN executing on the data processing system, a predicted skew factor for the communication channel based on the input dataset; and
outputting, by the data processing system, the predicted skew factor for the communication channel to a PCB design tool to modify the PCB design based on the predicted skew factor.

2. The method of claim 1, further comprising:
configuring, by the data processing system, the skew rate ANN to include an input layer having a plurality of input nodes, where each input node receives a different characteristic of the PCB design or communication channel;
configuring, by the data processing system, the skew rate ANN to include a hidden layer having a plurality of hidden nodes, where each hidden node applies weight values to inputs from the input nodes of the input layer and combines the inputs to generate an output; and
configuring, by the data processing system, the skew rate ANN to include an output layer having an output node, where the output node combines outputs from the hidden nodes to generate the predicted skew factor.

3. The method of claim 1, wherein the PCB characteristics comprise glass weave properties of a glass weave surrounding the communication channel.

4. The method of claim 1, further comprising:
modifying, by the PCB design tool, the PCB design based on the predicted skew factor for the communication channel by modifying a degree of rotation of a differential stripline pair of the communication channel relative to a glass weave of the PCB design to reduce skew in the communication channel to be within a design tolerance based on the predicted skew factor.

5. The method of claim 1, wherein outputting the predicted skew factor for the communication channel to a PCB design tool to modify the PCB design based on the predicted skew factor comprises outputting one or more design constraints.

6. The method of claim 5, wherein the one or more design constraints comprise a maximum wire length for the communication channel based on the predicted skew factor and a skew tolerance of the PCB design.

7. The method of claim 1, wherein the skew rate ANN is a two layer feedforward ANN implementing a Bayesian regularization training algorithm.

8. The method of claim 1, further comprising:
modifying, by the PCB design tool, the PCB design based on the predicted skew factor for the communication channel to reduce skew in the communication channel to be within a design tolerance based on the predicted skew factor.

9. The method of claim 1, further comprising:
modifying, by the PCB design tool, the PCB design based on the predicted skew factor for the communication channel at least by one of:
modifying a rotation of an orientation of wire traces of the communication channel relative to a glass weave;
modifying an orientation of the glass weave relative to the wire traces of the communication channel; or
modifying material properties of materials surrounding the communication channel in the PCB design.

10. The method of claim 1, wherein the communication channel is a differential stripline pair of a bus in the PCB design.

11. A computer program product comprising a computer readable storage medium having a computer readable program stored therein, wherein the computer readable program, when executed on a computing device, causes the computing device to:
generate a training dataset for training a skew rate artificial neural network (ANN), wherein the training dataset comprises a plurality of sets of data, and wherein each set of data corresponds to a particular set of printed circuit board (PCB) and communication channel characteristics;
train the skew rate ANN based on the training dataset to generate a trained skew rate ANN;
receive an input dataset representing a set of PCB characteristics and communication channel characteristics for a PCB design and communication channel of the PCB design;
generate, by the trained skew rate ANN, a predicted skew factor for the communication channel based on the input dataset; and
output the predicted skew factor for the communication channel to a PCB design tool to modify the PCB design based on the predicted skew factor.

12. The computer program product of claim 11, wherein the computer readable program further causes the computing device to:
configure the skew rate ANN to include an input layer having a plurality of input nodes, where each input node receives a different characteristic of the PCB design or communication channel;
configure the skew rate ANN to include a hidden layer having a plurality of hidden nodes, where each hidden node applies weight values to inputs from the input nodes of the input layer and combines the inputs to generate an output; and
configure the skew rate ANN to include an output layer having an output node, where the output node combines outputs from the hidden nodes to generate the predicted skew factor.

13. The computer program product of claim 11, wherein the PCB characteristics comprise glass weave properties of a glass weave surrounding the communication channel.

14. The computer program product of claim 11, wherein the computer readable program further causes the computing device to:
modify, by the PCB design tool, the PCB design based on the predicted skew factor for the communication channel by modifying a degree of rotation of a differential stripline pair of the communication channel relative to a glass weave of the PCB design to reduce skew in the communication channel to be within a design tolerance based on the predicted skew factor.

15. The computer program product of claim 11, wherein the computer readable program further causes the computing device to output the predicted skew factor for the communication channel to a PCB design tool to modify the PCB design based on the predicted skew factor at least by outputting one or more design constraints.

16. The computer program product of claim 15, wherein the one or more design constraints comprise a maximum wire length for the communication channel based on the predicted skew factor and a skew tolerance of the PCB design.

17. The computer program product of claim 11, wherein the skew rate ANN is a two layer feedforward ANN implementing a Bayesian regularization training algorithm.

18. The computer program product of claim 11, wherein the computer readable program further causes the computing device to:
modify, by the PCB design tool, the PCB design based on the predicted skew factor for the communication channel to reduce skew in the communication channel to be within a design tolerance based on the predicted skew factor.

19. The computer program product of claim 11, wherein the computer readable program further causes the computing device to:
modify, by the PCB design tool, the PCB design based on the predicted skew factor for the communication channel at least by one of:
modifying a rotation of an orientation of wire traces of the communication channel relative to a glass weave;
modifying an orientation of the glass weave relative to the wire traces of the communication channel; or
modifying material properties of materials surrounding the communication channel in the PCB design.

20. An apparatus comprising:
a processor; and
a memory coupled to the processor, wherein the memory comprises instructions which, when executed by the processor, cause the processor to:
generate a training dataset for training a skew rate artificial neural network (ANN), wherein the training dataset comprises a plurality of sets of data, and wherein each set of data corresponds to a particular set of printed circuit board (PCB) and communication channel characteristics;
train the skew rate ANN based on the training dataset to generate a trained skew rate ANN;
receive an input dataset representing a set of PCB characteristics and communication channel characteristics for a PCB design and communication channel of the PCB design;
generate, by the trained skew rate ANN, a predicted skew factor for the communication channel based on the input dataset; and
output the predicted skew factor for the communication channel to a PCB design tool to modify the PCB design based on the predicted skew factor.
